(19) United States
(12) Patent Application Publication
(10) Pub. No.: US 2012/0285288 A1
(43) Pub. Date: Nov. 15, 2012

(54) SECURING ROTATING CONTROLS

(76) Inventor: Andrew M. Chinigo, Jacksonville, FL (US)

(21) Appl. No.: 13/106,344

(22) Filed: May 12, 2011

(51) Int. Cl. G05G 5/06; B23P 11/00

(52) U.S. Cl. 74/531; 29/525.01

(57) ABSTRACT

A device forms a wedge shape and is operative to be placed between a control surface and the underside of a rotating control knob. A frictional coating is applied to an upper and or lower surface of the wedge to improve resistance to rotation of the knob, and to maintain an inserted position of the wedge. A tab extends from a trailing end of the device to facilitate insertion and removal. The tab may include two portions hingedly connected to the upper and lower surface of the body, and the body includes a biasing member which urges the surfaces and portions apart. The wedge may be formed with resilient material, to increase friction and provide utility for a wide variety of gap sizes. A plurality of wedges may be interconnected to facilitate connection to control panels with a plurality of rotating controls.

### FIELD OF THE INVENTION

The present invention relates to a device and method for securing a rotating control, and particularly to preventing unwanted rotation of a rotatable control.

### BACKGROUND OF THE INVENTION

A variety of machines and apparatuses are manipulated or regulated through a rotating control, the control having a knob, dial, or wheel. These controls typically include a rheostat or potentiometer component having a rotating shaft that extends through a control surface. The control operates as part of a machine or apparatus, by being rotated in either direction depending on the machine operator's desired effect. One example is a volume potentiometer, as commonly found on stereo devices, used by an operator of the stereo to increase or decrease the volume output by rotating a knob associated with the potentiometer

### SUMMARY OF THE INVENTION

A device for securing a rotating control, where the rotating control includes a rotating knob, wheel, or dial connected to a control shaft comprises a body having a thickness, defined as the distance between an upper surface and a lower surface, where the thickness increases from an insertion end to a trailing end, and a groove integrally formed on the insertion end of the device.

In another embodiment, the device further comprises a protrusion extending away from the trailing end, operable for a user of the device to grip the device with the fingers of the user's hand. Additional embodiments of the device feature the protrusion having an upper portion connected to said lower surface, and a lower portion connected to said upper surface, where the upper and lower portions are hingedly connected and further include a biasing member, such as a spring or other elastic material, that urges the upper and lower portions of the protrusion, as well as the upper and lower surfaces of the device, apart.

Alternative embodiments include a series of indentations or gripping elements covering at least a portion of an outer surface of the device;; the thickness of the device increasing at a variable rate from the insertion end to the trailing end; a compartment that is situated between the upper and lower surface of the device, the compartment could be closed to the atmosphere and include a pressurized fluid, situated to apply a tensile force on the device in resistance in resistance to an external compressive force applied on the device or the compartment may be sealed and contain a pressurized fluid; a frictionally enhancing material coating at least a portion of an outer surface of the device; or, in embodiments that include the protrusion on the trailing end, the protrusion further extending away from a plane connecting the insertion end and the trailing end on the device and having a ridge on the distal end of the protrusion, operable to engage the upper side of the knob, wheel, or dial on the rotating control.

The invention is also direct to a method for securing a rotating control, the rotating control including a rotating knob connected to a shaft, the shaft extending through a control surface, the method comprising adjusting a position of the rotating control and inserting a rotation securing device into a gap defined between an lower surface of the knob and the control surface, the device comprising a body having a thickness, defined as the distance between an upper surface and a lower surface, where the thickness increases from an insertion end to a trailing end, a groove integrally formed on the insertion end of the device, and a protrusion extending away from the trailing end, operable for a user of the device to grip the device with the fingers of the user's hand. In alternative embodiments of this method for securing a rotating control, the device is inserted by applying a compressive force on the protrusion, where the protrusion further comprises an upper portion connected to the lower surface of the device, and an lower portion connected to the upper surface of the device, and further includes a biasing member operative to urge the upper and lower portions apart, as well as the upper and lower surfaces apart. Additional methods may further include, but is not limited to: a protrusion on the device further extending away from a plane connecting the insertion end and the trailing end on the device and having a ridge on the distal end of the protrusion, operable to engage the upper side of the knob, wheel, or dial on the rotating control; and the device further comprising a compartment that is internalized within the device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings where:

FIG. 1 depicts a perspective view of a control securing device;

FIG. 2 depicts a side view of the device of FIG. 1;

FIG. 3 depicts a side view of a rotating control of the Prior Art;

FIG. 4 depicts a side view of the device of FIGS. 1 and 2 being inserted into the rotating control of FIG. 3;

FIG. 5 depicts the device of FIG. 1 inserted and secured with respect to the rotating control of FIG. 3;

FIG. 6 depicts a side view of the device of FIG. 1 having an upper lip;

FIG. 7 depicts the device of FIG. 1 having an upper lip, the device being inserted into the rotating control of the Prior Art;

FIG. 8 depicts a perspective view of a plurality of devices of FIG. 1, interconnected;

FIG. 9 depicts a cross sectional view of a device having an internal chamber containing a pressurized fluid;

FIG. 10 depicts a side view of the device of FIG. 1, having an attachment mateable to the control surface of the rotating control; and

FIG. 11A-B depicts a side view of the device having an internal spring and a tab connected to a hinge

FIG. 12 depicts a perspective view of the device of FIG. 11A-B having an internal resistant material.

### DETAILED DESCRIPTION OF THE INVENTION

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

Device 100 allows a user to secure a rotating control 200 against unwanted or unintentional rotation. Rotating controls, such as the tuning knobs on musical instruments, can be precise and highly sensitive to movement. Although the rotating control 200 is ideally manufactured to easily rotate, this easy rotation leaves the control susceptible to unwanted or unintentional rotation should the machine be knocked, touched, vibrated, pressured, or otherwise disturbed. The device functions to secure rotating controls having a knob 202 attached to a rotating shaft 206.

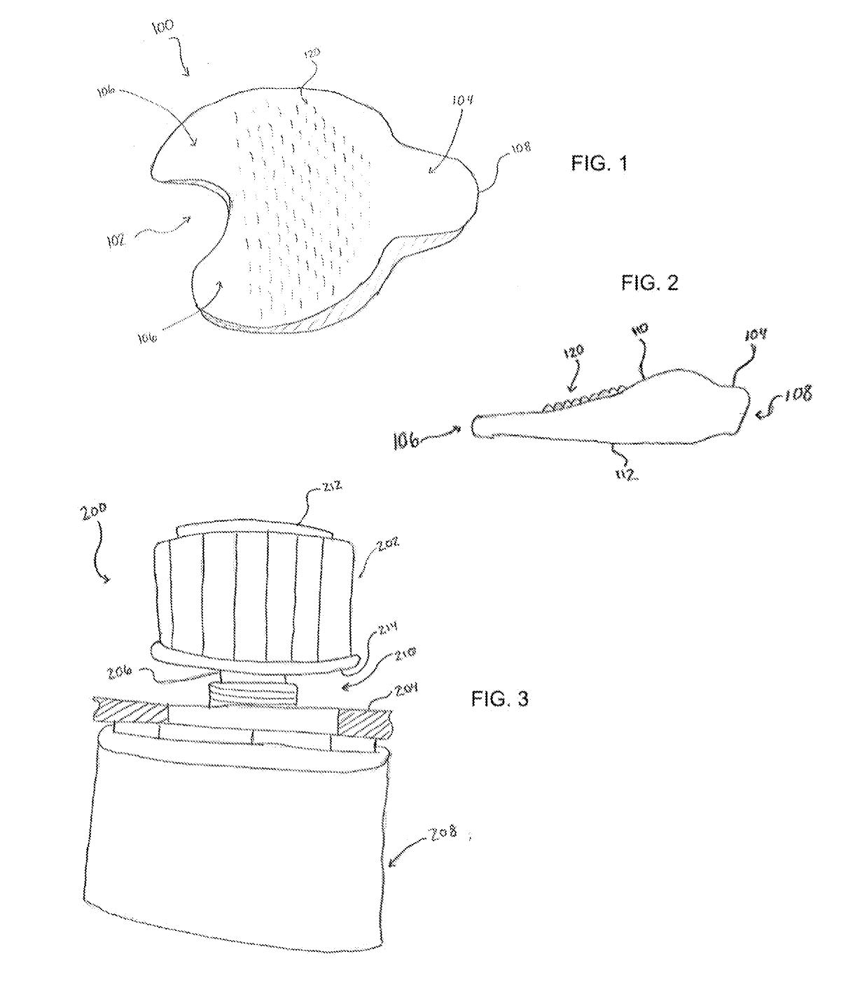

Referring now to FIGS. 1 and 2, one embodiment of device 100 is a single, wedge shaped component, the body of device 100 having a thickness, defined as the distance between an upper surface 110 and a lower surface 112 on the body of device 100, which gradually increases from an insertion end 106 to a trailing end 108. In one embodiment, the thickness increases linearly along the length of the device, while in alternative embodiments the thickness increases variably. Along the insertion end 106 is an integrally formed groove 102, and advantageously provided along the trailing end 108 is a protruding tab 104, to allow a user of device 100 to easily grasp device 100 with fingers of a hand. In one embodiment, device 100 has an outer perimeter that is rounded, such that device 100 forms a horseshoe shape. In some embodiments, at least a portion of device 100 is advantageously manufactured from a friction enhancing material. Device 100 may further include a friction enhancing covering 120 coating at least a portion of an outer surface of device 100, operative to increase a frictional contact between device 100 and the rotating control 200. In one embodiment, the friction enhancing covering 120 advantageously comprises grooves, ridges, or indentions along upper and or lower surfaces 110, 112. In another embodiment, the friction enhancing covering 120 advantageously comprises a thin material or a chemical that coats at least a portion of an outer surface of device 100. In these embodiments, the thin material or chemical should be selected such that device 100 has an increased frictional contact with another surface. One skilled in the art will appreciate that device 100 can have alternative embodiments, such as a wedge shape having an outer perimeter that is substantially straight, or a rounded trailing end 108 that does not include protruding tab 104.

Several embodiments of device 100 include a protruding tab 104 to allow a user of device 100 to easily grasp device 100 with fingers of a hand. Tab 104 protrudes away from the body of device 100 in a direction defined to extend from insertion end 106 to trailing end 108. Tab 104 may be a substantially straight component, or it may be angular or curved. In some embodiments, tab 104 advantageously extends from multiple points on trailing end 108, providing multiple points from which a user may grip tab 104. In one embodiment, tab 104 is integrally formed on the trailing end 108 as an extension of the body of device 100. In alternative embodiments, tab 104 is a separate attachment secured to the trailing end 108.

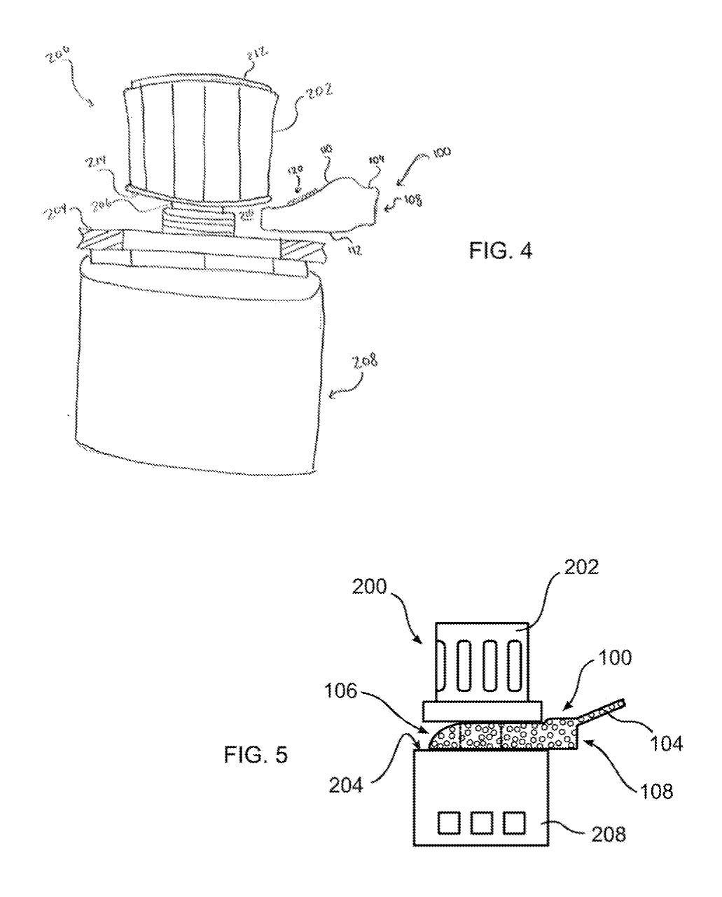

Referring now to FIGS. 3, 4, and 5, a typical rotating control 200 of the prior art includes a knob 202, having an upper side 212 and a lower side 214, a rheostat or potentiometer 208, a control shaft 206 connecting the potentiometer 208 and the knob 202, and a control surface 204 through which the control shaft 206 extends. Device 100 is positionable in a gap 210 located between the lower side 214 of the knob 202 and the control surface 204. Insertion of device 100 generates a pressure between the knob 202 and the control surface 204, thereby creating a resistance to turning of knob 202. The frictional contact between device 100 and the rotating control 200 further limits unintentional or unwanted rotation of knob 202.

Integrally formed groove 102 is positioned to extend around control shaft 206. As device 100 is forced farther into gap 210, the wedge shape of device 100 applies additional pressure to knob 202, thereby increasing the force necessary to rotate knob 202. This resulting force is adjustable by the user depending on the force used to insert device 100 between knob 202 and the control surface 204, and the extent of insertion.

In use, a user manually inserts or removes device 100 from gap 210 to cause resistance to rotation, and to permit free rotation, respectively. Protruding tab 104 aides the user in manually inserting or removing device 100, by ensuring that at least a portion of device 100 extends from gap 210, where it may be grasped by a user's fingers or a tool (not shown). It is further contemplated that a machine (not shown) may be used to insert and or remove device 100. Embodiments of device 100 that include a friction enhancing covering 120 on the outer surface of device 100 aid in the functionality of the device by increasing the frictionally applied pressure that device 100 is exerted between knob 202 and control surface 204.

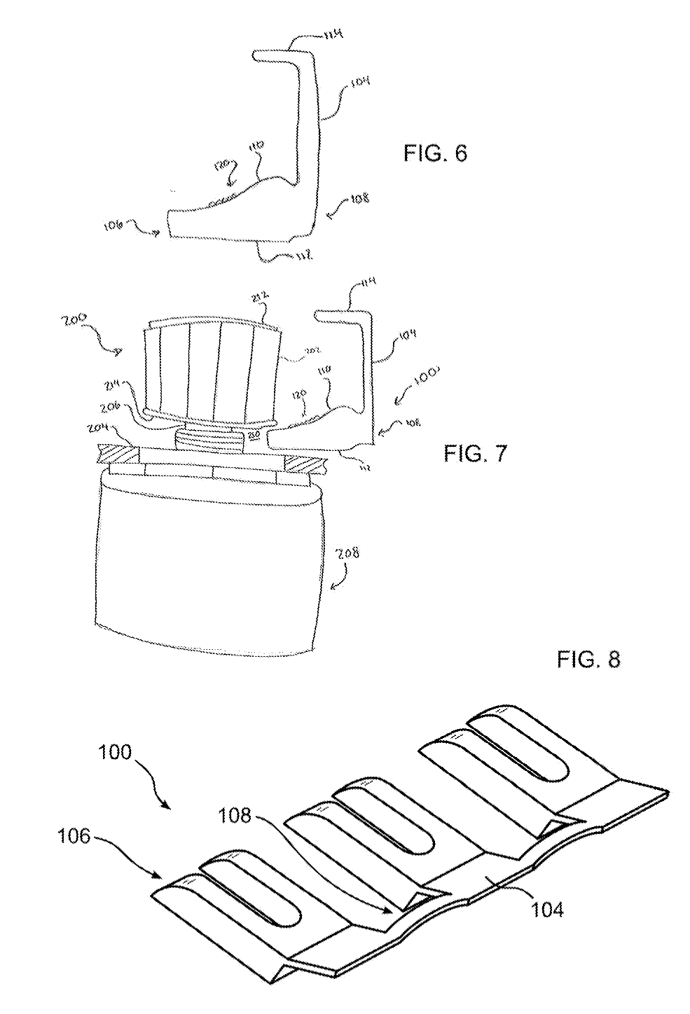

For some rotational controls 200, knob 202 may be frictionally applied to the control shaft 206, for example by an interference fit. For these controls, device 100 must be carefully secured such that the pressure is not sufficient to separate knob 202 from control shaft 206. Alternatively, with reference to FIGS. 5 and 6, an embodiment of device 100 includes an overhanging ridge 114 formed to extend from protruding tab 104 of trailing end 108. Ridge 114 is secured over upper side 212 of control knob 202, whereby device 100 exerts a compressive or limiting force upon knob 202, thereby preventing a frictionally applied knob 206 from separating from control shaft 206.

Referring now to FIG. 8, in one embodiment tab 104 is extended to connect device 100 with at least one additional device 100, forming a single interconnected device operable to simultaneously secure multiple rotating controls. Such an embodiment would be advantageous, for example, on a machine with multiple rotation controls. In alternative embodiments, a separate attachment or protrusion can be situated on device 100, operable to connect to another device 100. This separate attachment or protrusion extends from at least a portion of the outer surface of said device.

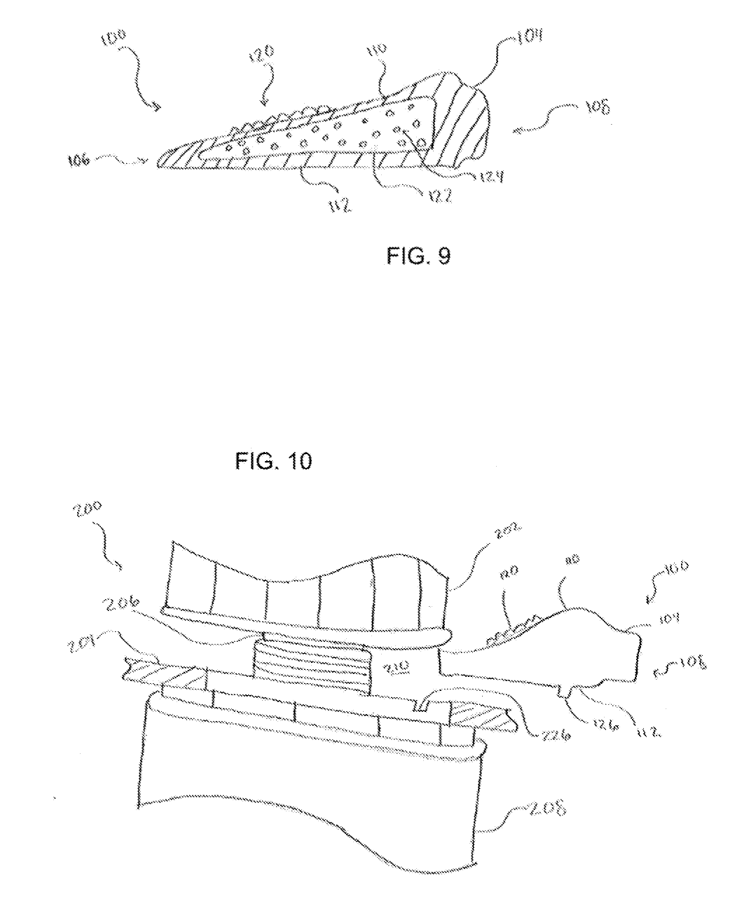

Referring now to FIG. 9, an additional embodiment of device 100 advantageously places upper surface 110 and lower surface 112 in resilient tension. Surfaces 110, 112 may be resiliently connected by internally subjecting the surfaces 110, 112 to a pressurized fluid 124, either gaseous or liquid, through an internally sealed chamber 122. Internal chamber 122 may also advantageously feature a spring, foam, or other resistance material situated within chamber 122, positioned to resist compressive force acting upon surfaces 110, 122. In additional embodiments, internal chamber 122 may be open to the atmosphere and feature at least one type of resistant material situated within chamber 122. Chamber 122 may also be advantageously manufactured from different material than the other components of device 100. Chamber 122 may be advantageously situated throughout any internal portion of device 100. In some embodiments, chamber 122 covers a substantial internal portion of the body of device 100. Other embodiments of device 100 position chamber 122 in a smaller portion of device 100, such as tab 104 as one example.

Referring now to FIG. 10, an additional embodiment of device 100 further includes an extension 126, either integrally formed or separable, that enables device 100 to connect with a mating portion 226 of a rotating control 200. Such an extension could be positioned at any portion of the device that is engagable with rotating control 200. An extension 126 may be positioned, for example, on the lower surface 112 of the device, connectable with a mating portion 226 located along the control surface 204. Alternatively, an extension could be positioned within gap 102, connectable with a mating portion on shaft 206, or on the upper surface 110 of device 100, connectable with a mating portion on knob 202. Said extensions may be selected from a variety of connecting components known in the art. Two possible examples are threaded connectors and quick-snap connectors. As discussed above, tab 104 may also be an attachable extension.

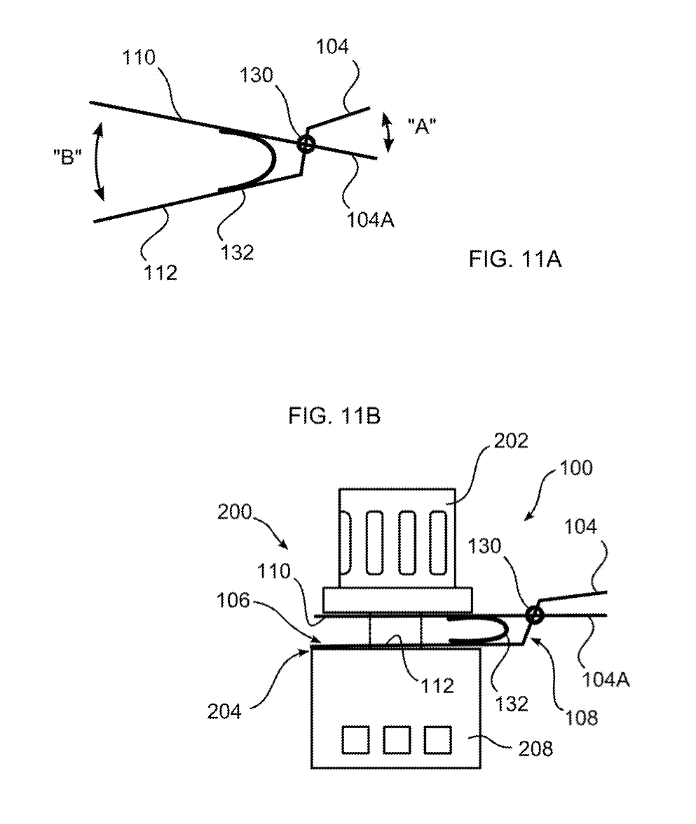

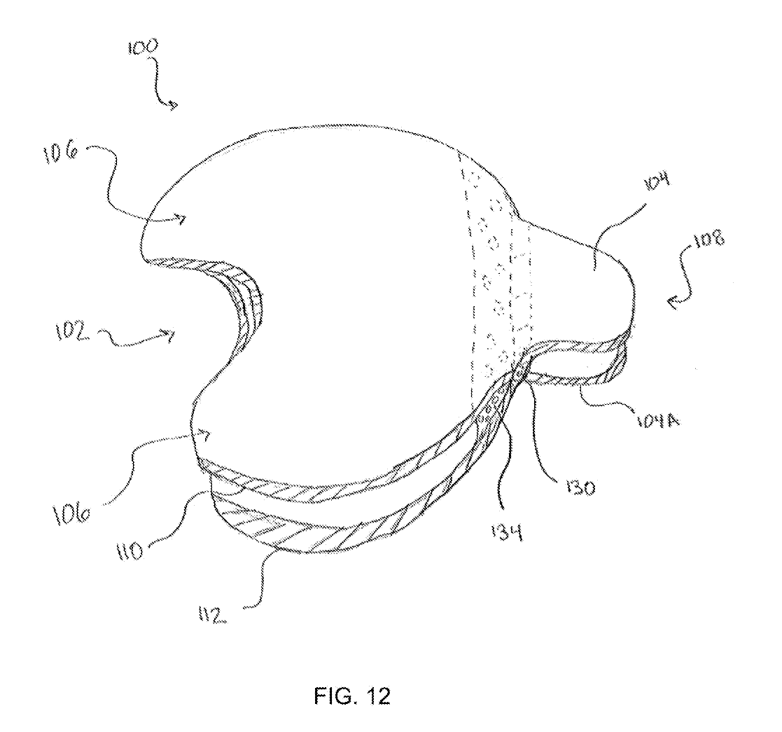

Referring now to FIG. 11A-B and 12, an additional embodiment of device 100 advantageously features a protrusion comprising an upper portion 104, a lower portion 104A, said upper portion 104 and said lower portion 104A connected by a hinge 130. Device 100 further includes a biasing member 132, 134 operative to urge the upper portion 104 and lower portion 104A apart, as well as said upper surface 110 and said lower surface 112 of the body of device 100 apart. In one embodiment, the biasing member is a spring 132. In embodiments featuring of device 100 featuring a spring 132, the spring may is at least one of the following: flat spring, coil spring, balance spring, leaf spring, v-spring, torsion spring, gas spring, or cantilever. In other embodiments, the biasing member may be an elastic material 134. In these embodiments, device 100 further operates by the user of the device applying a compressive force on the protrusion 104, 104A of device 100 (“A” direction) resulting in a compressive force on the surfaces 110, 112 of device 100 (“B” direction). After device 100 has been inserted into gap 210, the user releases protrusion 104, 104A and the biasing member 132, 134 exerts a force on the upper surface 110 and the lower surface 112 of device 100, which thereby generates a pressure between the knob 202 and the control surface 204, thereby creating a resistance to turning of knob 202.

Device 100 may be manufactured from a variety of materials, including polymers, and other synthetic or natural materials including foam, rubber, resilient material, wood, metal, glass, ceramic, paper, cardboard, and fabric. Device 100 can be manufactured through a variety of methods, for example molding, including injection molding, casting, pressing, folding, stamping, and forming, although other methods may be used, as would be understood by one skilled in the art. It is advantageous for the material to be capable of applying a stable pressure to rotating control 200. In some embodiments, device 100 may advantageously utilize a combination of materials assembled or formed in layers or coatings, using any known or hereinafter developed methods of combining and joining materials. While certain materials may be selected to improve the resiliency of device 100, other materials may be selected to improve the frictional properties of the surface of device 100. Materials may also be selected to improve the gripping ability of the device, particularly on areas where a user's fingers are likely to interact with the device, such as protruding tab 104.

Although device 100 is particularly adept at securing rotating controls with a highly sensitive potentiometer 208 or the like, one skilled in the art will appreciate the variety of applications for device 100 to which device 100 may be employed. For example, device 100 is useful to control any sensitive rotating control 200 that is susceptible to being knocked, jarred, or otherwise loosened, irrespective of size or function of the control. The device is adaptable to controls in a variety of settings including, but not limited to, musical instruments, stereo equipment, electronics, industrial controls, medical devices, automotive controls, and or valves controlled by at least one rotating knob or wheel. Device 100, in many embodiments, is a singular component and transportable by a user, and is easily deployed.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. A device for securing a rotating control, where said rotating control includes a rotating knob, wheel, or dial connected to a control shaft, said device comprising:
a body having a thickness, defined as the distance between an upper surface and a lower surface, where the thickness increases from an insertion end to a trailing end, the body forming a groove disposed integrally on the insertion end of said device adapted to receive the control shaft.

2. The device according to claim 1, further comprising a series of indentations or gripping elements covering at least a portion of an outer surface of said device.

3. The device according to claim 1, where the thickness of said device is increasing at a variable rate from the insertion end to the trailing end.

4. The device according to claim 1, further comprising a compartment that is disposed between said upper surface and said lower surface.

5. The device according to claim 4, said compartment is sealed with respect to the atmosphere and contains a pressurized gas or fluid.

6. The device according to claim 1, further including a biasing member operative to urge said upper and lower portions apart.

7. The device according to claim 1, further comprising a frictionally enhancing material coating at least a portion of an outer surface of said device.

8. A device for securing a rotating control, where said rotating control includes a rotating knob, wheel, or dial connected to a control shaft, said device comprising:
a body having a thickness, defined as the distance between an upper surface and a lower surface, where the thickness increases from an insertion end to a trailing end, the body forming a groove disposed integrally on the insertion end of said device adapted to receive the control shaft, and a protrusion extending away from the trailing end operable to enable a user of said device to grip said device with the fingers of the user's hand.

9. The device according claim 8, further comprising a compartment that is disposed between said upper surface and said lower surface.

10. The device according to claim 9, said compartment is sealed with respect to the atmosphere and contains a pressurized gas or fluid.

11. The device according to claim 8, further comprising at least one biasing member disposed between said upper and lower surfaces and configured to bias said upper and lower surfaces mutually apart.

12. The device according to claim 8, said protrusion further comprising an upper portion connected to said lower surface, and a lower portion connected to said upper surface, said upper and lower portions hingedly connected, and further including a biasing member operative to urge said upper and lower portions, and said upper and lower surfaces, apart.

13. The device according to claim 12, wherein said biasing member is at least one of: flat spring, coil spring, balance spring, leaf spring, v-spring, torsion spring, gas spring, or cantilever.

14. The device according to claim 8, further comprising a series of indentations, a series of gripping elements, or a frictionally enhancing material covering at least a portion of an outer surface of said device.

15. The device according to claim 8, where the thickness of said device is increasing at a variable rate from the insertion end to the trailing end.

16. The device according to claim 8, said protrusion further extending away from a plane connecting the insertion end and the trailing end on said device and having a ridge on the distal end of said protrusion, operable to engage the upper side of the knob, wheel, or dial on said rotating control.

17. A method for securing a rotating control, the rotating control including a rotating knob connected to a shaft, the shaft extending through a control surface, the method comprising:
adjusting a position of the rotating control; and
inserting a rotation securing device into a gap defined between an lower surface of said knob and the control surface, said device comprising a body having a thickness, defined as the distance between an upper surface and a lower surface, where the thickness increases from an insertion end to a trailing end, the body forming a groove disposed integrally on the insertion end of said device adapted to receive the control shaft and a protrusion extending away from the trailing end operable to enable a user of said device to grip said device with the fingers of the user's hand.

18. The method according to claim 17, said protrusion on said device further extending away from a plane connecting the insertion end and the trailing end on said device and having a ridge on the distal end of said protrusion, operable to engage the upper side of the knob, wheel, or dial on said rotating control.

19. The method according to claim 17, said device further comprising a compartment that is internalized within said device.

20. The method according to claim 17, said insertion further comprising applying a compressive force on the protrusion of said device, said protrusion further comprising an upper portion connected to said lower surface, and a lower portion connected to said upper surface, said upper and lower portions hingedly connected, and further including a biasing member operative to urge said upper and lower portions, and said upper and lower surfaces, apart.
